(19) United States
(12) Patent Application Publication
(10) Pub. No.: US 2026/0342130 A1
(43) Pub. Date: Oct. 29, 2026

(54) DISPLAY DEVICE WITH MULTI-POWER DELIVERY FUNCTION AND OPERATING METHOD THEREOF

(71) Applicant: Wistron Corporation, New Taipei City (TW)

(72) Inventors: LEI SUN, New Taipei City (TW); JUNXIN QIU, New Taipei City (TW); MIN ZHOU, New Taipei City (TW); LU SHENG ZHOU, New Taipei City (TW); YONGBO LI, New Taipei City (TW)

(21) Appl. No.: 19/260,964

(22) Filed: Jul. 7, 2025

(30) Foreign Application Priority Data
Apr. 28, 2025 (CN) 202510551837.3

(51) Int. Cl. H02J 13/38; H02J 13/10

(52) U.S. Cl. CPC H02J 13/38; H02J 13/10

(57) ABSTRACT

A display device with multi-power delivery (PD) function and an operating method thereof are provided. The display device includes an internal power supply, a first interface, a second interface, a first PD controller, a second PD controller and a control circuit. The first PD controller is electrically connected to the first interface. The first PD controller is configured to determine whether the first interface has a PD capability. The second PD controller is configured to determine whether the second interface has a first PD requirement. The control circuit is electrically connected to the first PD controller and the second PD controller. The control circuit is configured to selectively provide power from the internal power supply and/or the first interface according to a first determination result of the first PD controller, a second determination result of the second PD controller, the PD capability and the first PD requirement.

### CROSS-REFERENCE TO RELATED APPLICATION

This application claims priority to and the benefit of China Application Serial No. 202510551837.3, filed in the China National Intellectual Property Administration (CNIPA) on Apr. 28, 2025, the entire content of which is incorporated herein by reference as if fully set forth below in its entirety and for all applicable purposes.

### TECHNICAL FIELD

The present disclosure relates to a display, more particularly, to a display device with multi-power delivery (PD) function and an operating method thereof.

### BACKGROUND

With the development of universal serial bus (USB) Type-C, Thunderbolt (TBT) and PD technologies, USB Type-C interfaces are usually used as both signal transmission interfaces and power ports in almost all current mobile devices such as notebooks and mobile phones. As for display devices, the PD function is usually added to the TBT or USB Type-C input interface of the display in current designs.

Ideally, it is hoped that the display device has multi-PD function to simultaneously provide power to a plurality of external devices. However, in reality, it is still difficult to achieve due to factors such as excessive increase in power, balanced display function, peripheral interface power supply function, efficiency under various loads, and bottlenecks in high-power output of power boards. Even if the power board of the display device is designed to be a dynamic allocation type, after the power board preferentially allocates power to the internal system, the remaining power may not fully meet the power supply needs of the external devices, resulting in a significant reduction in the power absorption capacity of the external devices, and even affecting the operation of certain functions.

In addition, electronic waste has become a global issue, including a large number of unused or discarded power adapters. Therefore, it is also an important issue that how to effectively reuse these idle power adapters to reduce the generation of electronic waste and simultaneously reduce the resource consumption and carbon footprint caused by manufacturing new power adapters to assist in environmental sustainability and cannot be delayed.

### SUMMARY

In view of this, a display device with multi-PD function and an operating method thereof are proposed in the present disclosure to effectively solve the above-mentioned problems in the prior art.

An embodiment of the present disclosure is a display device with multi-PD function. In this embodiment, the display device includes an internal power supply, a first interface, a second interface, a first PD controller, a second PD controller and a control circuit. The first PD controller is electrically connected to the first interface. The first PD controller is configured to determine whether the first interface has a PD capability. The second PD controller is electrically connected to the second interface. The second PD controller is configured to determine whether the second interface has a first PD requirement. The control circuit is electrically connected to the first PD controller and the second PD controller. The control circuit is configured to selectively provide power from the internal power supply and/or the first interface according to a first determination result of the first PD controller, a second determination result of the second PD controller, the PD capability and the first PD requirement.

Another embodiment of the present disclosure is an operating method of a display device. In this embodiment, the operating method includes determining whether the first interface has a PD capability to generate a first determination result; determining whether the second interface has a first PD requirement to generate a second determination result; and selectively providing power from the internal power supply and/or the first interface according to the first determination result, the second determination result, the PD capability and the first PD requirement.

### BRIEF DESCRIPTION OF THE DRAWINGS

FIG. 1 is a schematic diagram illustrating a display device with multi-PD function connected to different electronic devices through a plurality of interfaces in one embodiment of the present disclosure.

FIG. 2 and FIG. 3 are schematic diagrams respectively illustrating that how the display device with multi-PD function determines different PD paths according to the PD capacity of an external power adapter in the present disclosure.

FIG. 4 is a schematic diagram illustrating that the multi-channel PD path switching circuit provides power to a USB module from an internal power supply when the display device does not receive power from a power adapter in the present disclosure.

FIG. 5 is a schematic diagram illustrating that when the display device receives power from the power adapter, the multi-channel PD path switching circuit controls the power adapter to provide power to the USB module in the present disclosure.

FIG. 6 to FIG. 9 are schematic diagrams of different PD paths of the second power management circuit operating in a boost state with left-end input and right-end output, a buck state with left-end input and right-end output, a boost state with right-end input and left-end output and a buck state with right-end input and left-end output respectively in the present disclosure.

FIG. 10A to FIG. 10E are flowcharts illustrating an operating method of a display device with multi-PD function in one embodiment of the present disclosure.

### DETAILED DESCRIPTION

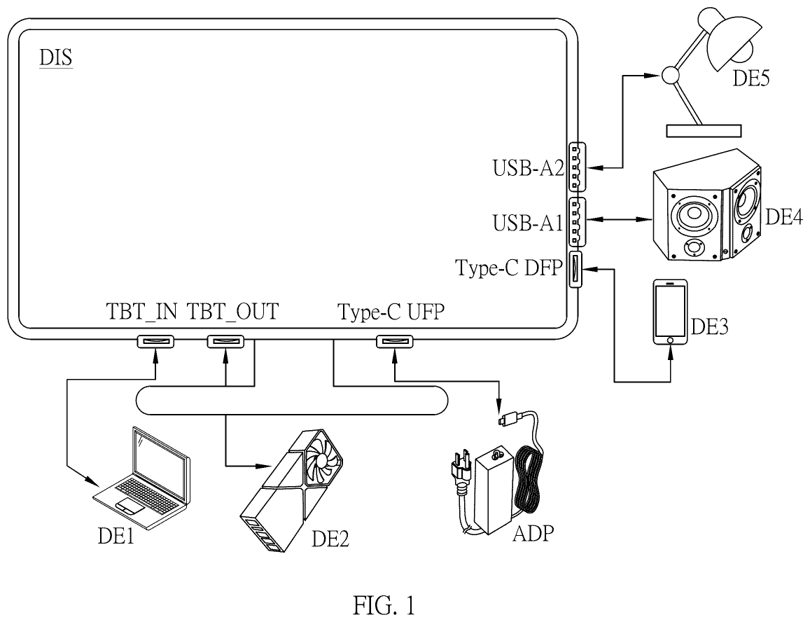

The following describes the implementation methods disclosed in the present disclosure through specific embodiments in conjunction with FIG. 1 to FIG. 10E. Those skilled in the art may understand the advantages and effects of the present disclosure from the contents disclosed in this specification. However, the following disclosure is not intended to limit the protection scope of the present disclosure.

The structures shown in the drawings of the present disclosure are not drawn according to the shape and size ratios of actual implementation. For example, the sizes of certain elements are exaggerated for convenience of explanation.

Further, it will be understood that when an element is referred to as being “connected to” another element, it may be directly coupled to the other element or indirectly coupled to the other element, or intervening elements may be present. As used herein, “electrical connection” may refer to a physical and/or non-physical electrical connection, or may be a wired and/or wireless electrical connection.

It should be understood that, although the terms “first”, “second”, “third”, etc. may be used herein to describe various elements, these elements should not be limited by these terms. These terms are only used to distinguish one element from another. Thus, a “first element” discussed below could be termed a second element without departing from the teachings herein.

An embodiment of the present disclosure is a display device with multi-PD function. In this embodiment, the display device with multi-PD function includes a plurality of interfaces for electrically connecting to different types of electronic devices, such as a notebook, a mobile phone, a tablet computer, a speaker, a desk lamp and a power adapter.

Please refer to FIG. 1. FIG. 1 is a schematic diagram illustrating the display device with multi-PD function connected to different electronic devices through the plurality of interfaces in this embodiment. As shown in FIG. 1, the plurality of interfaces of the display device DIS may include a video input interface, a video output interface, and a USB data transmission interface, such as a first interface Type-C UFP, a second interface TBT_IN, a third interface TBT_OUT, a fourth interface Type-C DFP, a fifth interface USB-A1 and a sixth interface USB-B, which are respectively disposed on an outer frame of the display device DIS.

For example, the first interface Type-C UFP may be electrically connected to an external power supply device (such as a power adapter) ADP with PD capability, and the second interface TBT_IN, the third interface TBT_OUT, the fourth interface Type-C DFP, the fifth interface USB-A1 and the sixth interface USB-A2 may be electrically connected to a first device DE1 to a fifth device DE5 with PD requirements respectively, but not limited to this. The second interface TBT_IN and the third interface TBT_OUT are Thunderbolt (TBT) interfaces, which use a high-speed data transmission and connection technology and may dynamically adjust the bandwidth of data and video according to the device and application.

In actual applications, the first interface Type-C UFP, the second interface TBT_IN, the third interface TBT_OUT, the fourth interface Type-C DFP, the fifth interface USB-A1 and the sixth interface USB-A2 of the display device DIS may be a USB Type-C upstream facing port (UFP) interface, a TBT input interface, a TBT output interface, a USB Type-C downstream facing port (DFP) interface, a USB Type-A interface respectively, but not limited to this.

It should be noted that, although the present disclosure is mainly described by designing the display device DIS to be electrically connected to an external power supply device (such as a power adapter) ADP with PD capability through the first interface Type-C UFP, in fact, the present disclosure may also be designed to design the display device DIS to be electrically connected to an external power supply device (such as a power adapter) ADP with PD capability through other types of interfaces (such as video input interfaces such as HDMI/DP/TBT_IN, video output interfaces such as DP_OUT/TBT_OUT, USB data transmission upstream port, etc.), depending on actual needs.

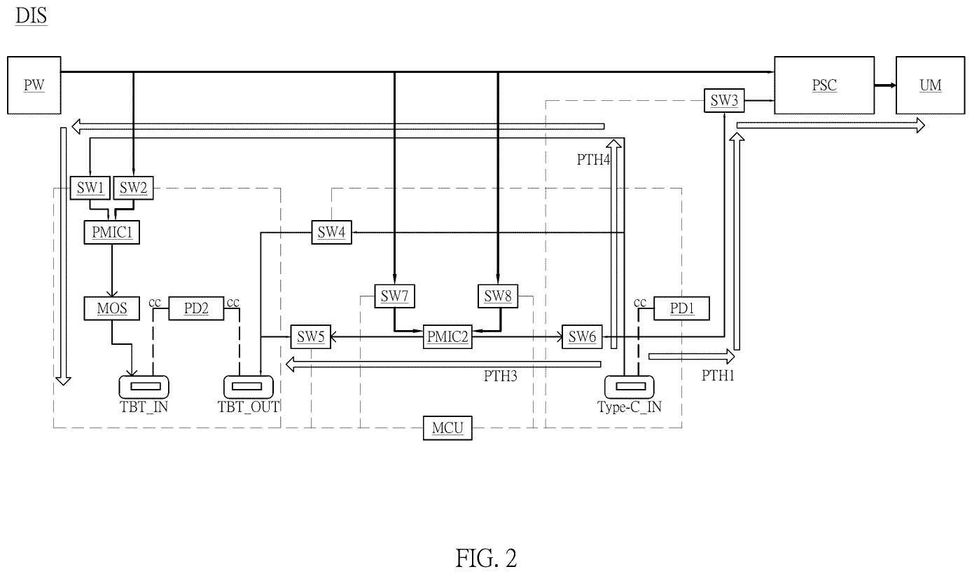

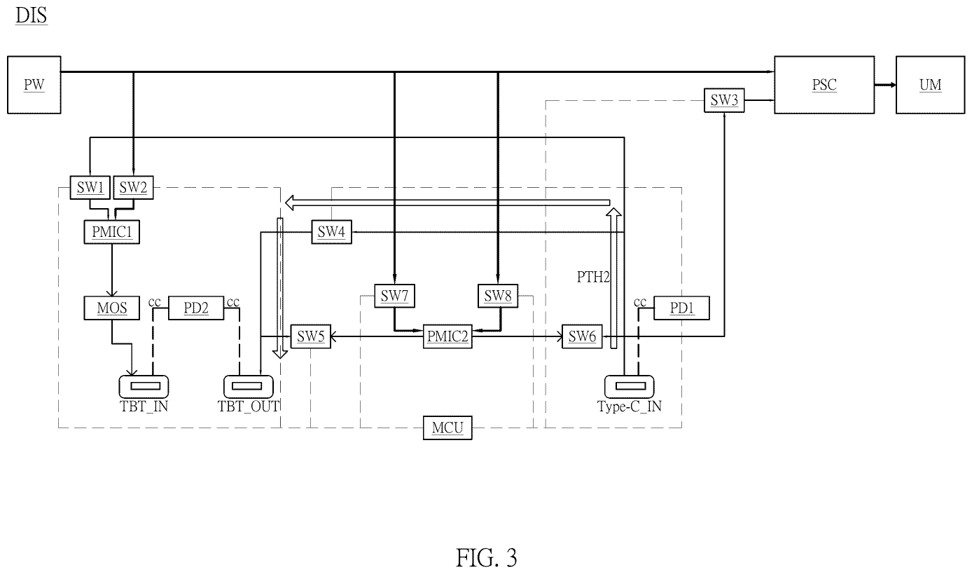

Please refer to FIG. 2 and FIG. 3. FIG. 2 and FIG. 3 are schematic diagrams respectively illustrating that how a display device with multi-PD function determines different PD paths according to the PD capacity of an external power adapter in an embodiment of the present disclosure. As shown in FIG. 2 and FIG. 3, the display device DIS includes a control circuit MCU, a first PD controller PD1, a second PD controller PD2, a first power management circuit PMIC1, a second power management circuit PMIC2, an internal power supply PW, a multi-channel PD path switching circuit PSC, a USB module UM, a metal-oxide-semiconductor field-effect transistor (MOSFET) MOS, a first interface Type-C_IN, a second interface TBT_IN, a third interface TBT_OUT, a first switch SW1, a second switch SW2, a third switch SW3, a fourth switch SW4, a fifth switch SW5, a sixth switch SW6, a seventh switch SW7 and an eighth switch SW8.

The control circuit MCU is electrically connected to the first PD controller PD1, the second PD controller PD2 and the first switch SW1 to the eighth switch SW8 respectively. The first PD controller PD1 is electrically connected to the first interface Type-C_IN. The second PD controller PD2 is electrically connected to the second port TBT_IN and the third port TBT_OUT respectively. In fact, the control circuit MCU may be a micro-controller unit (MCU) or a general-purpose input/output (GPIO) to control the first switch SW1 to the eighth switch SW8 to be turned on or off, but not limited to this.

The first PD controller PD1 is configured to determine whether the first interface Type-C_IN has a PD capability. For example, the first power controller PD1 may determine whether the first interface Type-C_IN has the PD capability according to whether the first interface Type-C_IN is electrically connected to an external power supply device with the PD capability (e.g., the power adapter ADP in FIG. 1), but not limited to this. The second power controller PD2 is configured to determine whether the second interface TBT_IN has a first PD requirement and whether the third interface TBT_OUT has a second PD requirement. For example, the second PD controller PD2 may determine whether the second interface TBT_IN has the first PD requirement and whether the third interface TBT_OUT has the second PD requirement based on whether the second interface TBT_IN is electrically connected to a first powered device with a first PD requirement (e.g., the first device DE1 in FIG. 1) and whether the third interface TBT_OUT is electrically connected to a second powered device with a second PD requirement (e.g., the second device DE2 in FIG. 1), but not limited to this. The control circuit MCU is configured to receive the first determination result of the first PD controller PD1 and the second determination result of the second PD controller PD2 respectively, and selectively determine to provide power through the internal power supply PW and/or the first interface Type-C_IN and correspondingly turns on or off the first switch SW1 to the eighth switch SW8 according to the first determination result of the first PD controller PD1, the second determination result of the second PD controller PD2, the PD capability and the first PD requirement.

The first switch SW1 is electrically connected between the first interface Type-C_IN and the first power management circuit PMIC1. The second switch SW2 is electrically connected between the internal power supply PW and the first power management circuit PMIC1. The third switch SW3 is electrically connected between the first interface Type-C_IN and the multi-channel PD path switching circuit PSC. The fourth switch SW4 is electrically connected between the first interface Type-C_IN and the third interface TBT_OUT. The fifth switch SW5 is electrically connected to the third port TBT_OUT and the second power management circuit PMIC2 respectively. The sixth switch SW6 is electrically connected to the first interface Type-C_IN and the second power management circuit PMIC2 respectively. The seventh switch SW7 is electrically connected between the internal power supply PW and the second power management circuit PMIC2. The eighth switch SW8 is electrically connected between the internal power supply PW and the second power management circuit PMIC2.

The first power management circuit PMIC1 is electrically connected to the first switch SW1, the second switch SW2 and the MOSFET MOS respectively. The MOSFET MOS is electrically connected to the second interface TBT_IN. The second power management circuit PMIC2 is electrically connected to the fifth switch SW5, the sixth switch SW6, the seventh switch SW7 and the eighth switch SW8 respectively.

It should be noted that the first power management circuit PMIC1 and the second power management circuit PMIC2 may be power management chips that realize bidirectional power transmission and management. When the first switch SW1 is turned on, the first power management circuit PMIC1 receives power from the first interface Type-C_IN with PD capability. For example, the power supply may come from the external power supply device (such as the power adapter ADP in FIG. 1) to which the first interface Type-C_IN is electrically connected, but not limited to this in the present disclosure. When the second switch SW2 is turned on, the first power management circuit PMIC1 receives power from the internal power supply PW. When the second interface TBT_IN has a first PD requirement, the first power management circuit PMIC1 provides power to the second interface TBT_IN through the MOSFET MOS, so as to provide power to the first powered device (such as the first device DE1 in FIG. 1) electrically connected thereto through the second interface TBT_IN, but not limited to this. When the seventh switch SW7 or the eighth switch SW8 is turned on, the second power management circuit PMIC2 receives power from the internal power supply PW. When the fifth switch SW5 or the sixth switch SW6 is turned on, the second power management circuit PMIC2 provides power to the first interface Type-C_IN or the third interface TBT_OUT through the fifth switch SW5 or the sixth switch SW6.

In actual applications, the second interface TBT_IN and the third interface TBT_OUT may share a 2-port PD controller (such as RTS5458H), and an additional slave device, Inter-Integrated Circuit (I2C), is reserved to communicate with the first power supply controller PD1 electrically connected to the first interface Type-C_IN to achieve a power pass-through function.

The multi-channel PD path switching circuit PSC is electrically connected between the internal power supply PW and the USB module UM. The multi-channel PD path switching circuit PSC is configured to selectively provide power to the USB module UM directly from the internal power supply PW or switch to provide power to the USB module UM from the first interface Type-C_IN. When the third switch SW3 is turned off, the multi-channel PD path switching circuit PSC is switched to directly provide power to the USB module UM from the internal power supply PW. When the third switch SW3 is turned on, the multi-channel PD path switching circuit PSC is switched to provide power to the USB module UM from the first interface Type-C_IN and stop providing power from the internal power supply PW simultaneously.

It should be noted that, since the interface design of a conventional display device usually only has the second interface TBT_IN with PD capability, the first PD controller PD1, the second PD controller PD2, the first power management circuit PMIC1 and the second power management circuit PMIC2 are additionally disposed in the display device DIS of the present disclosure to realize the multi-PD function.

In actual applications, the first PD controller PD1 may be used to obtain the PD information cc such as the PD capability of the external power supply device (such as the power adapter ADP in FIG. 1) electrically connected to the first interface Type-C_IN, and the second PD controller PD2 may be used to obtain the PD information cc such as the first PD requirement of the first powered device (such as the first device DE1 in FIG. 1) electrically connected to the second interface TBT_IN and the second PD requirement of the second powered device (such as the second device DE2 in FIG. 1) electrically connected to the third interface TBT_OUT, so as to serve as a basis for subsequent determination of whether the power is provided by the first interface Type-C_IN. The first PD controller PD1 and the second PD controller PD2 are mainly used to manage the USB PD protocol, and their functions may include the following:
(1) Power negotiation: The first PD controller PD1 and the second PD controller PD2 may be used to manage the power negotiation between the master device (e.g., the display device DIS) and the slave device (e.g., the first device DE1). The voltage and current required by the devices may be determined through the USB PD protocol, thereby providing an optimized charging solution.
(2) Multi-voltage support: The USB PD protocol may support voltages ranging from 5V to 20V. The first PD controller PD1 and the second PD controller PD2 may be used to switch between different voltage levels to meet the needs of different devices.
(3) Protection function: The first PD controller PD1 and the second PD controller PD2 may have a variety of protection mechanisms, such as over-voltage protection (OVP), under-voltage protection (UVP), over-current protection (OCP), etc., to ensure the safety of the charging process.
(4) Communication function: The first PD controller PD1 and the second PD controller PD2 may coordinate data transmission and power transmission through the USB Type-C interface to ensure that the device may transmit data and power simultaneously.

Next, different embodiments will be used to describe in detail how the display device with multi-PD function of the present disclosure determines different PD paths according to the PD capacity of the external power adapter.

Assuming that the design power of the USB module UM is 45 W, when the PD capacity of the first interface Type-C_IN of the display device DIS is ≤45 W, it means that the PD capacity of the external power supply device (such as the power adapter ADP in FIG. 1) electrically connected to the first interface Type-C_IN is insufficient, and the control circuit MCU turns off the third switch SW3, so that the multi-channel PD path switching circuit PSC still maintains the internal power supply PW to directly provide power to the USB module UM without turning on the first interface Type-C_IN for power supply.

As shown in FIG. 2, assuming that the design power of the USB module UM is 45 W and the second PD requirement of the third interface TBT_OUT is 65 W, when 45 W<the PD capacity of the first interface Type-C_IN≤65 W, it means that the PD capacity of the first interface Type-C_IN is sufficient to meet the design power of the USB module UM. The control circuit MCU may turn on the third switch SW3, so that the multi-channel PD path switching circuit PSC switches to the first interface Type-C_IN to provide power to the USB module UM through the first PD path PTH1 and stop providing power from the internal power supply PW, but the PD capacity of the first interface Type-C_IN may still not meet the second PD requirement of the third interface TBT_OUT.

As shown in FIG. 3, when 65 W<the PD capacity of the first interface Type-C_IN≤120 W, it means that the PD capacity of the first interface Type-C_IN is sufficient to meet the second PD requirement of the third interface TBT_OUT. The control circuit MCU may turn on the fourth switch SW4, so that the first interface Type-C_IN may directly provide power to the third interface TBT_OUT through the second PD path PTH2, so as to save the power loss caused by passing through the second power management circuit PMIC2.

As shown in FIG. 2, when 120 W<the PD capacity of the first interface Type-C_IN≤150 W, it means that the PD capacity of the first interface Type-C_IN is sufficient to simultaneously meet the design power of the USB module UM and the second PD requirement of the third interface TBT_OUT. The control circuit MCU may simultaneously turn on the third switch SW3, the fifth switch SW5 and the sixth switch SW6, so that the first interface Type-C_IN may provide power to the USB module UM through the first PD path PTH1 and provide power to the third interface TBT_OUT through the third PD path PTH3.

As shown in FIG. 2, when 150 W<the PD capacity of the first interface Type-C_IN≤200 W, it means that the PD capacity of the first interface Type-C_IN should be sufficient to meet the first PD requirement of the second interface TBT_IN. The control circuit MCU may turn on the first switch SW1, so that the first interface Type-C_IN may provide power to the first power management circuit PMIC1 through the fourth PD path PTH4 and after reasonable allocation according to the actual power, the first power management circuit PMIC1 may provide power to the second interface TBT_IN.

As shown in FIG. 2, when 200 W<the PD capacity of the first interface Type-C_IN≤250 W, it means that the PD capacity of the first interface Type-C_IN should be sufficient to meet the design power of the USB module UM and the first PD requirement of the second interface TBT_IN. The control circuit MCU may simultaneously turn on the first switch SW1 and the third switch SW3, so that the first interface Type-C_IN may provide power to the USB module UM through the first PD path PTH1 and to the first power management circuit PMIC1 through the fourth PD path PTH4, and after reasonable allocation according to the actual power, the first power management circuit PMIC1 may provide power to the second interface TBT_IN.

As shown in FIG. 2, when 250 W<the PD capacity of the first interface Type-C_IN≤300 W, it means that the PD capacity of the first interface Type-C_IN should be sufficient to simultaneously meet the design power of the USB module UM and the second PD requirement of the third interface TBT_OUT. The control circuit MCU may simultaneously turn on the first switch SW1, the fifth switch SW5 and the sixth switch SW6, so that the first interface Type-C_IN may provide power to the third interface TBT_OUT through the third PD path PTH3 and to the first power management circuit PMIC1 through the fourth PD path PTH4, and after reasonable allocation according to the actual power, the first power management circuit PMIC1 may provide power to the second interface TBT_IN.

As shown in FIG. 2, when 300 W<the PD capacity of the first interface Type-C_IN, it means that the PD capacity of the first interface Type-C_IN should be sufficient to simultaneously meet the design power of the USB module UM, the first PD requirement of the second interface TBT_IN and the second PD requirement of the third interface TBT_OUT. The control circuit MCU may simultaneously turn on the first switch SW1, the third switch SW3, the fifth switch SW5 and the sixth switch SW6, so that the first interface Type-C_IN may provide power to the USB module UM through the first PD path PTH1, provide power to the third interface TBT_OUT through the third PD path PTH3, and provide power to the first power management circuit PMIC1 through the fourth PD path PTH4, and after reasonable allocation according to the actual power, the first power management circuit PMIC1 may provide power to the second interface TBT_IN.

It should be noted that although the above embodiment is described by taking the power adapter ADP electrically connected to the first interface Type-C UFP as an example, the present disclosure may actually be more flexibly designed to electrically connect the power adapter ADP to any Type-C interface based on customized specifications and cost considerations, and not limited to this.

In actual applications, the design of the multi-channel PD path switching circuit PSC must meet the following conditions: (1) when the display device DIS does not receive power from the first interface Type-C_IN with PD capability, the internal power supply PW of the display device DIS directly provides power to the USB module UM; and (2) when the display device DIS receives power from the first interface Type-C_IN, it prioritizes seamless switching to the first interface Type-C_IN to provide power to the USB module UM and simultaneously stop providing power from the internal power supply PW of the display.

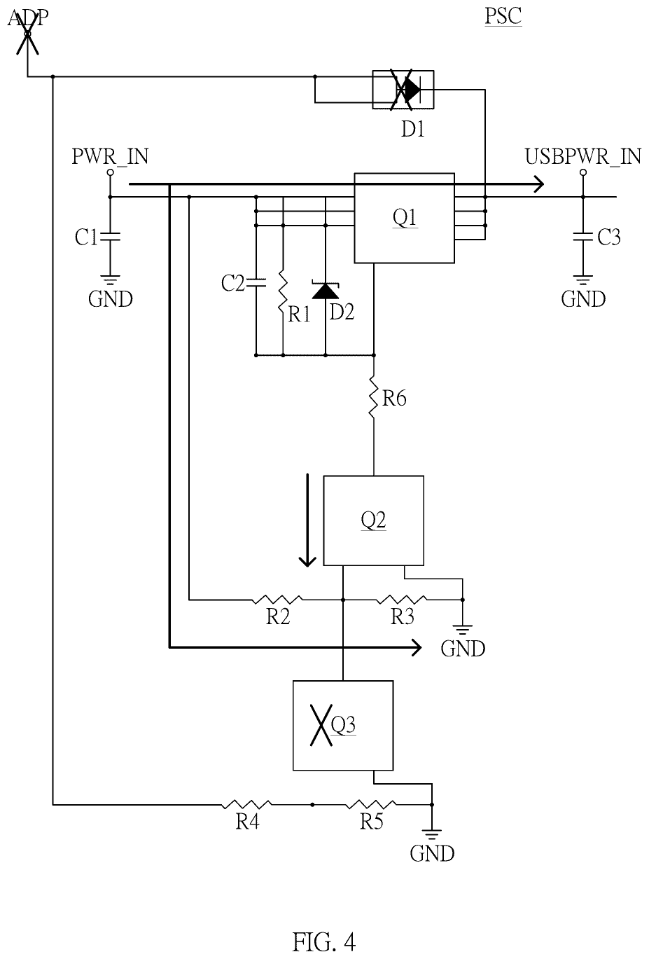

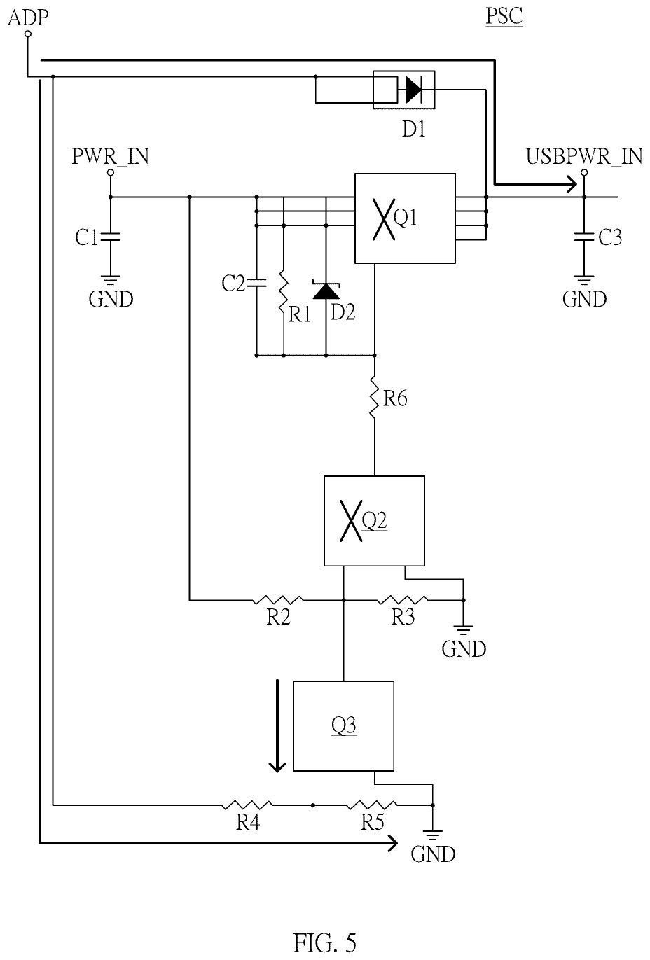

In one embodiment, as shown in FIG. 4 and FIG. 5, the multi-channel PD path switching circuit PSC may include P-type high-power MOSFETs Q1~Q3, a diode D1, a Schottky diode D2, capacitors C1~C3 and resistors R1~R6. The diode D1 is electrically connected between the power adapter ADP and the USB module power input terminal USBPWR_IN. The P-type high power MOSFET Q1 is electrically connected to the internal power input terminal PWR_IN, the USB module power input terminal USBPWR_IN and the P-type high power MOSFET Q2 respectively. The P-type high power MOSFET Q2 is electrically connected to the P-type high power MOSFETs Q1 and Q3 and the ground terminal GND respectively. The P-type high power MOSFET Q3 is electrically connected to the P-type high power MOSFET Q2, between the resistors R4 and R5, and the ground terminal GND. The resistor R1 is electrically connected between the internal power input terminal BPWR_IN and the resistor R6. The resistors R2 and R3 are connected in series between the internal power input terminal BPWR_IN and the ground terminal GND. The resistors R4 and R5 are connected in series between the power adapter ADP and the ground terminal GND. The resistor R6 is electrically connected between the P-type high power MOSFETs Q1 and Q2. The capacitor C1 is electrically connected between the internal power input terminal BPWR_IN and the ground terminal GND. The capacitor C2 is electrically connected between the internal power input terminal BPWR_IN and the resistor R6. The capacitor C3 is electrically connected between the USB module power input terminal USBPWR_IN and the ground terminal GND. The Schottky diode D2 is electrically connected between the internal power input terminal BPWR_IN and the resistor R6 and the voltage drop of the Schottky diode D2 is only 0.25V.

It should be noted that since the internal power input terminal BPWR_IN of the display device DIS will not be damaged by power backflow under normal circumstances without special design, the design of the multi-channel PD path switching circuit PSC in FIG. 4 and FIG. 5 may omit another P-type high-power MOSFET that is conventionally set back-to-back with the P-type high-power MOSFET Q1 to avoid power backflow, thereby greatly saving costs and circuit area.

Please refer to FIG. 4. When the display device does not receive power from the power adapter ADP, the P-type high-power MOSFETs Q1 and Q2 are turned on and the diode D1 and the P-type high-power MOSFET Q3 are turned off. The PD path of the internal power input terminal BPWR_IN is supplied to the USB module power input terminal USBPWR_IN through the high-power MOSFET Q1 and flows to the ground terminal GND through the resistors R2 and R3 in sequence, as shown by the thick black arrow.

Please refer to FIG. 5. When the display device receives power from the power adapter ADP, the P-type high-power MOSFETs Q1 and Q2 are turned off and the diode D1 and the P-type high-power MOSFET Q3 are turned on. The PD path of the power adapter ADP is supplied to the USB module power input terminal USBPWR_IN through the diode D1 and flows to the ground terminal GND through the resistors R4 and R5 in sequence, as shown by the thick black arrow.

It should be noted that based on comprehensive considerations such as cost, efficiency and flexibility, the second power management circuit PMIC2 in FIG. 2 may select a power management chip (such as MP420*) that may realize bidirectional power transmission and management, so that the third interface TBT_OUT in FIG. 2 may share the second power management circuit PMIC2 with the first interface Type-C_IN to realize the multi-PD function.

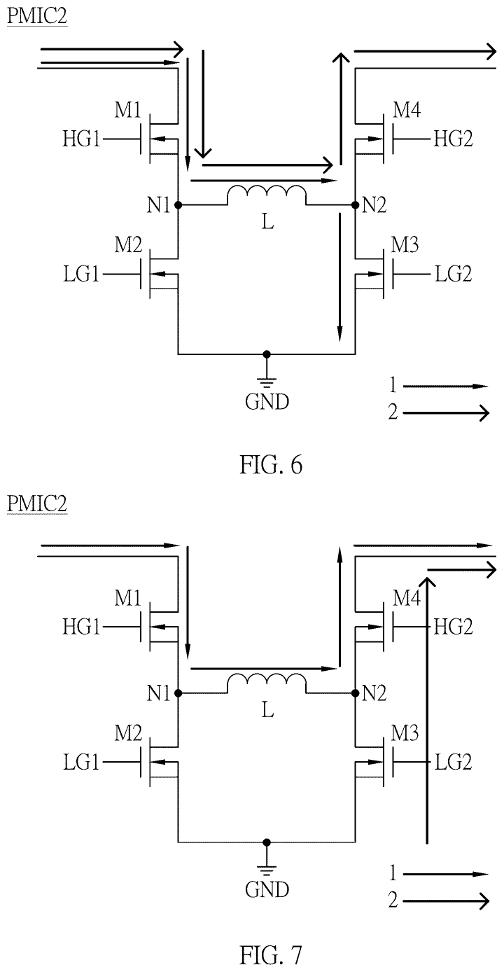

In one embodiment, as shown in FIG. 6 to FIG. 9, the second power management circuit PMIC2 supporting gallium nitride (GaN) may include four external N-type MOSFETs M1~M4 and an inductor L. The N-type MOSFET M2 is electrically connected between the N-type MOSFET M1 and the ground terminal GND. The N-type MOSFET M3 is electrically connected between the N-type MOSFET M4 and the ground terminal GND. A first terminal of the inductor L is electrically connected to a first node N1 between the N-type MOSFETs M1 and M2, and a second terminal of the inductor L is electrically connected to a second node N2 between the N-type MOSFETs M3 and M4. The gates of the N-type MOSFETs M1~M4 are controlled by gate control signals HG1, LG1, LG2 and HG2 to be turned on or off respectively.

It should be noted that the second power management circuit PMIC2 is mainly used to perform buck-boost DC-DC power conversion. It is responsible for converting the voltage inputted from the power supply into the voltage levels required by multiple subsystems based on the PDO coordinated by the power supply controller. For example, FIG. 6 to FIG. 9 are schematic diagrams of different PD paths of the second power management circuit PMIC2 operating in a boost state with left-end input and right-end output, a buck state with left-end input and right-end output, a boost state with right-end input and left-end output and a buck state with right-end input and left-end output respectively.

As shown in FIG. 6, when the second power management circuit PMIC2 operates in the boost state where power is inputted from the left-end, the N-type MOSFET M1 is controlled by the gate control signal HG1 to be turned on and the N-type MOSFET M2 is controlled by the gate control signal LG1 to be turned off, so that the first power path 1 and the second power path 2 pass through the N-type MOSFET M1 and the inductor L in sequence. When the N-type MOSFET M3 is turned on by the gate control signal LG2 and the N-type MOSFET M4 is turned off by the gate control signal HG2, the first power path 1 passes through the N-type MOSFET M3 to the ground terminal GND after passing through the inductor L. When the N-type MOSFET M3 is turned off by the gate control signal LG2 and the N-type MOSFET M4 is turned on by the gate control signal HG2, the second power path 2 passes through the N-type MOSFET M4 after passing through the inductor L and is then outputted from the right-end.

As shown in FIG. 7, when the second power management circuit PMIC2 operates in the buck state where power is inputted from the left-end, when the N-type MOSFET M1 is controlled by the gate control signal HG1 to be turned on, the N-type MOSFET M2 is controlled by the gate control signal LG1 to be turned off, the N-type MOSFET M3 is controlled by the gate control signal LG2 to be turned off, and the N-type MOSFET M4 is controlled by the gate control signal HG2 to be turned on, the first power path 1 passes through the N-type MOSFET M1, the inductor L and the N-type MOSFET M4 in sequence and is outputted from the right-end. When the N-type MOSFET M1 is controlled by the gate control signal HG1 to be turned off, the N-type MOSFET M2 is controlled by the gate control signal LG1 to be turned off, the N-type MOSFET M3 is controlled by the gate control signal LG2 to be turned on, and the N-type MOSFET M4 is controlled by the gate control signal HG2 to be turned on, the second power path 2 passes from the ground terminal GND through the N-type MOSFETs M3 and M4 in sequence and is outputted from the right-end.

As shown in FIG. 8, when the second power management circuit PMIC2 operates in the boost state where power is inputted from the right-end, the N-type MOSFET M4 is controlled by the gate control signal HG2 to be turned on and the N-type MOSFET M3 is controlled by the gate control signal LG2 to be turned off, so that the first power path 1 and the second power path 2 both pass through the N-type MOSFET M4 and the inductor L in sequence. When the N-type MOSFET M2 is turned on by the gate control signal LG1 and the N-type MOSFET M1 is turned off by the gate control signal HG1, the first power path 1 passes through the N-type MOSFET M2 to the ground terminal GND after passing through the inductor L. When the N-type MOSFET M2 is turned off by the gate control signal LG1 and the N-type MOSFET M1 is turned on by the gate control signal HG1, the second power path 2 passes through the N-type MOSFET M1 after passing through the inductor L and is outputted from the left-end.

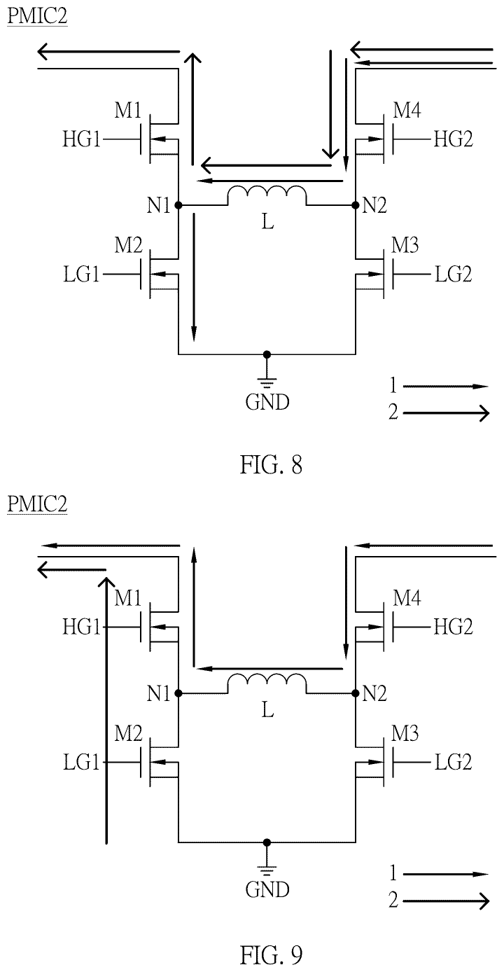

As shown in FIG. 9, when the second power management circuit PMIC2 operates in the buck state where power is inputted from the right-end, when the N-type MOSFET M4 is controlled by the gate control signal HG2 to be turned on, the N-type MOSFET M3 is controlled by the gate control signal LG2 to be turned off, the N-type MOSFET M2 is controlled by the gate control signal LG1 to be turned off, and the N-type MOSFET M1 is controlled by the gate control signal HG1 to be turned on, the first power path 1 flows through the N-type MOSFET M4, the inductor L and the N-type MOSFET M1 in sequence and is outputted from the left-end. When the N-type MOSFET M4 is turned off by the gate control signal HG2, the N-type MOSFET M3 is turned off by the gate control signal LG2, the N-type MOSFET M2 is turned on by the gate control signal LG1, and the N-type MOSFET M1 is turned on by the gate control signal HG1, the second power path 2 passes from the ground terminal GND through the N-type MOSFETs M2 and M1 in sequence and is outputted from the left-end.

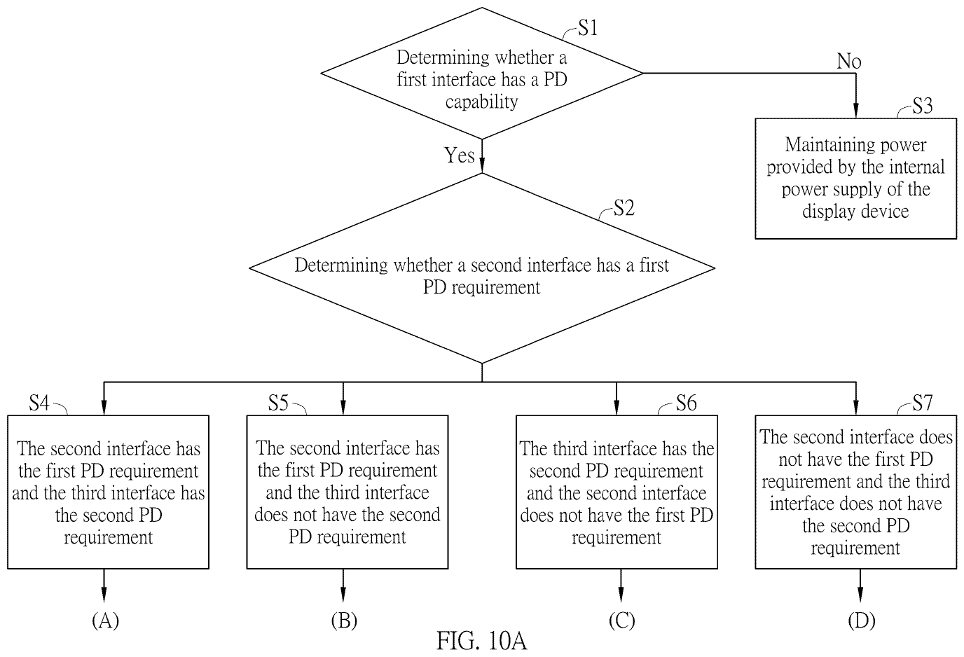

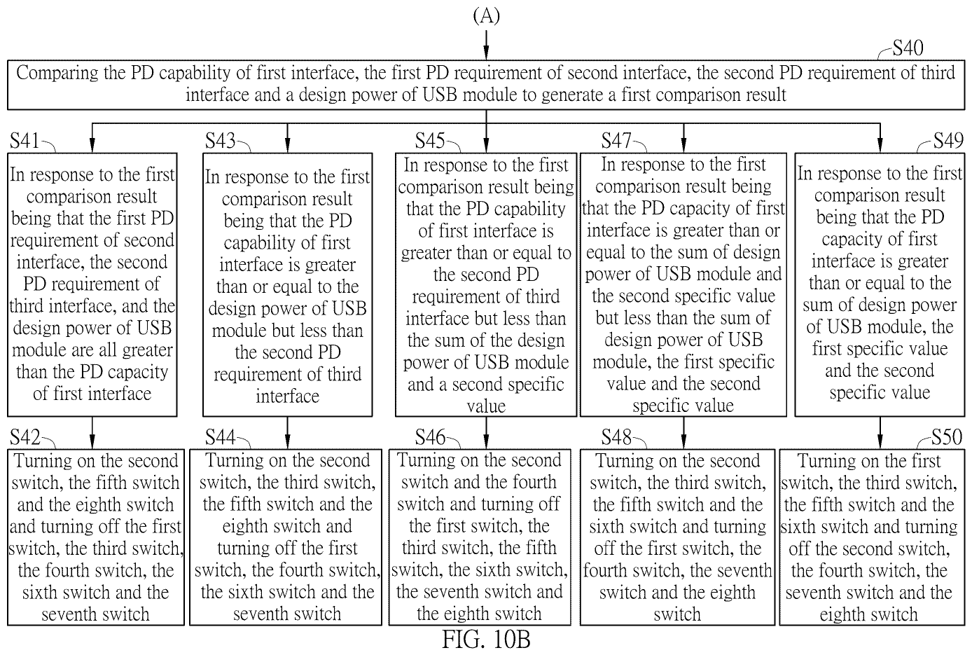

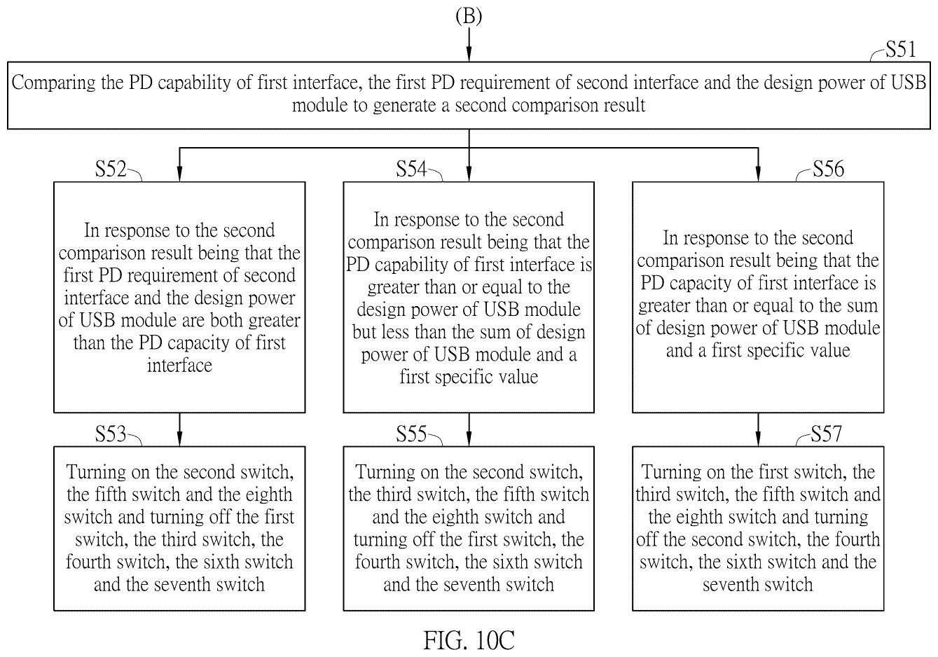

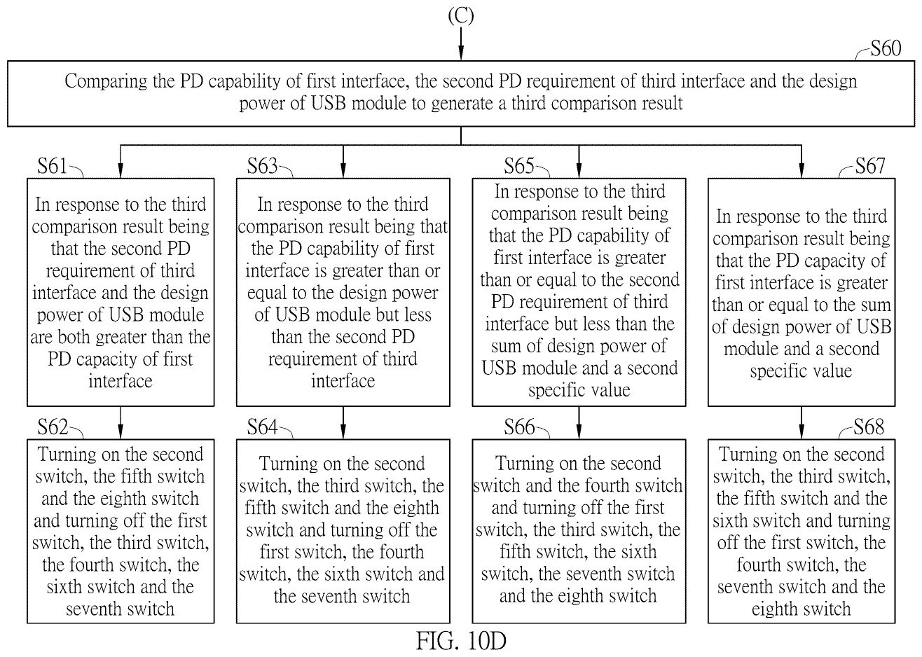

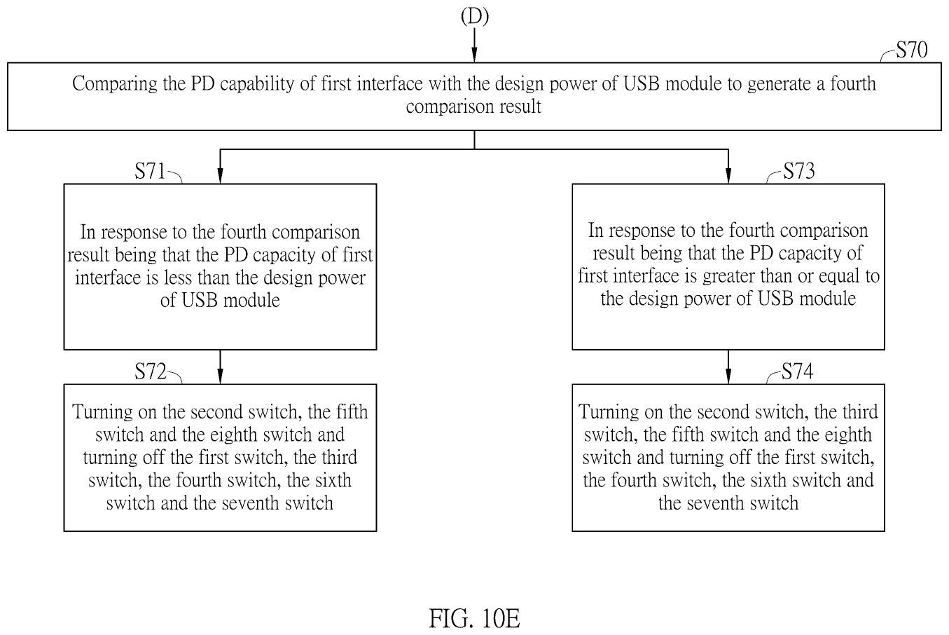

Please refer to FIG. 10A to FIG. 10E, which are flowcharts of a display device operating method in one embodiment of the present disclosure. As shown in FIG. 10A, the display device operation method includes the following steps:
Step S1: Determining whether a first interface has a PD capability (for example, determining whether the first interface is electrically connected to a power adapter ADP in FIG. 1);
Step S2: In response to the determination result of Step S1 being YES, determining whether a second interface has a first PD requirement (for example, determining whether the second interface is electrically connected to a first device DE1 in FIG. 1) and whether a third interface has a second PD requirement (for example, determining whether the third interface is electrically connected to a second device DE2 in FIG. 1);
Step S3: In response to the determination result of Step S1 being NO, maintaining power provided by the internal power supply of the display device;
Step S4: The determination result of Step S2 is that the second interface has the first PD requirement and the third interface has the second PD requirement;
Step S5: The determination result of Step S2 is that the second interface has the first PD requirement and the third interface does not have the second PD requirement;
Step S6: The determination result of Step S2 is that the third interface has the second PD requirement and the second interface does not have the first PD requirement; and
Step S7: The determination result of Step S2 is that the second interface does not have the first PD requirement and the third interface does not have the second PD requirement.

Next, the subsequent steps corresponding to the four different determination results of Step S2 (i.e., Steps S4 to S7) are described in detail.

As shown in FIG. 10B, in response to the first interface having the PD capability, the second interface having the first PD requirement and the third interface having the second PD requirement, Step S40 is further performed for comparing the PD capability of the first interface, the first PD requirement of the second interface, the second PD requirement of the third interface and a design power of the USB module (for example, the USB module UM in FIG. 2) to generate a first comparison result.

According to the different first comparison results generated in Step S40, there are the following possible situations:
(1) In response to the first comparison result being that the first PD requirement of the second interface, the second PD requirement of the third interface, and the design power of the USB module are all greater than the PD capacity of the first interface (Step S41), the control circuit MCU in FIG. 2 turns on the second switch SW2, the fifth switch SW5 and the eighth switch SW8 and turns off the first switch SW1, the third switch SW3, the fourth switch SW4, the sixth switch SW6 and the seventh switch SW7 (Step S42);
(2) In response to the first comparison result being that the PD capability of the first interface is greater than or equal to the design power of the USB module but less than the second PD requirement of the third interface (Step S43), the control circuit MCU in FIG. 2 turns on the second switch SW2, the third switch SW3, the fifth switch SW5 and the eighth switch SW8 and turns off the first switch SW1, the fourth switch SW4, the sixth switch SW6 and the seventh switch SW7 (Step S44);
(3) In response to the first comparison result being that the PD capability of the first interface is greater than or equal to the second PD requirement of the third interface but less than the sum of the design power of the USB module and a second specific value (e.g., the second PD requirement of the third interface divided by 0.9) (Step S45), the control circuit MCU in FIG. 2 turns on the second switch SW2 and the fourth switch SW4 and turns off the first switch SW1, the third switch SW3, the fifth switch SW5, the sixth switch SW6, the seventh switch SW7 and the eighth switch SW8 (Step S46);
(4) In response to the first comparison result being that the PD capacity of the first interface is greater than or equal to the sum of the design power of the USB module and the second specific value (e.g., the second PD requirement of the third interface divided by 0.9) but less than the sum of the design power of the USB module, the first specific value (e.g., the first PD requirement of the second interface divided by 0.9) and the second specific value (e.g., the second PD requirement of the third interface divided by 0.9) (Step S47), the control circuit MCU in FIG. 2 turns on the second switch SW2, the third switch SW3, the fifth switch SW5 and the sixth switch SW6 and turns off the first switch SW1, the fourth switch SW4, the seventh switch SW7 and the eighth switch SW8 (Step S48); and
(5) In response to the first comparison result being that the PD capacity of the first interface is greater than or equal to the sum of the design power of the USB module, the first specific value (for example, the first PD requirement of the second interface divided by 0.9) and the second specific value (for example, the second PD requirement of the third interface divided by 0.9) (Step S49), the control circuit MCU in FIG. 2 turns on the first switch SW1, the third switch SW3, the fifth switch SW5 and the sixth switch SW6 and turns off the second switch SW2, the fourth switch SW4, the seventh switch SW7 and the eighth switch SW8 (Step S50).

As shown in FIG. 10C, in response to the first interface having the PD capability, the second interface having the first PD requirement and the third interface not having the second PD requirement, Step S51 is further performed for comparing the PD capability of the first interface, the first PD requirement of the second interface and the design power of the USB module to generate a second comparison result.

According to the different second comparison results generated in Step S51, there are the following possible situations:
(1) In response to the second comparison result being that the first PD requirement of the second interface and the design power of the USB module are both greater than the PD capacity of the first interface (Step S52), the control circuit MCU in FIG. 2 turns on the second switch SW2, the fifth switch SW5 and the eighth switch SW8 and turns off the first switch SW1, the third switch SW3, the fourth switch SW4, the sixth switch SW6 and the seventh switch SW7 (Step S53);
(2) In response to the second comparison result being that the PD capability of the first interface is greater than or equal to the design power of the USB module but less than the sum of the design power of the USB module and a first specific value (e.g., the first PD requirement of the second interface divided by 0.9) (Step S54), the control circuit MCU in FIG. 2 turns on the second switch SW2, the third switch SW3, the fifth switch SW5 and the eighth switch SW8 and turns off the first switch SW1, the fourth switch SW4, the sixth switch SW6 and the seventh switch SW7 (Step S55); and
(3) In response to the second comparison result being that the PD capacity of the first interface is greater than or equal to the sum of the design power of the USB module and a first specific value (for example, the first PD requirement of the second interface divided by 0.9) (Step S56), the control circuit MCU in FIG. 2 turns on the first switch SW1, the third switch SW3, the fifth switch SW5 and the eighth switch SW8 and turns off the second switch SW2, the fourth switch SW4, the sixth switch SW6 and the seventh switch SW7 (Step S57).

As shown in FIG. 10D, in response to the first interface having the PD capability, the third interface having the second PD requirement and the second interface not having the first PD requirement, Step S60 is further performed for comparing the PD capability of the first interface, the second PD requirement of the third interface and the design power of the USB module to generate a third comparison result.

According to different third comparison results generated in Step S60, there are the following possible situations:
(1) In response to the third comparison result being that the second PD requirement of the third interface and the design power of the USB module are both greater than the PD capacity of the first interface (Step S61), the control circuit MCU in FIG. 2 turns on the second switch SW2, the fifth switch SW5 and the eighth switch SW8 and turns off the first switch SW1, the third switch SW3, the fourth switch SW4, the sixth switch SW6 and the seventh switch SW7 (Step S62);
(2) In response to the third comparison result being that the PD capability of the first interface is greater than or equal to the design power of the USB module but less than the second PD requirement of the third interface (Step S63), the control circuit MCU in FIG. 2 turns on the second switch SW2, the third switch SW3, the fifth switch SW5 and the eighth switch SW8 and turns off the first switch SW1, the fourth switch SW4, the sixth switch SW6 and the seventh switch SW7 (Step S64);
(3) In response to the third comparison result being that the PD capability of the first interface is greater than or equal to the second PD requirement of the third interface but less than the sum of the design power of the USB module and a second specific value (e.g., the second PD requirement of the third interface divided by 0.9) (Step S65), the control circuit MCU in FIG. 2 turns on the second switch SW2 and the fourth switch SW4 and turns off the first switch SW1, the third switch SW3, the fifth switch SW5, the sixth switch SW6, the seventh switch SW7 and the eighth switch SW8 (Step S66); and
(4) In response to the third comparison result being that the PD capacity of the first interface is greater than or equal to the sum of the design power of the USB module and a second specific value (for example, the second PD requirement of the third interface divided by 0.9) (Step S67), the control circuit MCU in FIG. 2 turns on the second switch SW2, the third switch SW3, the fifth switch SW5 and the sixth switch SW6 and turns off the first switch SW1, the fourth switch SW4, the seventh switch SW7 and the eighth switch SW8 (Step S68).

As shown in FIG. 10E, in response to the first interface having the PD capability and the second interface and the third interface having no PD requirement, Step S70 is further performed for comparing the PD capability of the first interface with the design power of the USB module to generate a fourth comparison result.

According to different fourth comparison results generated in Step S70, there are the following possible situations:
(1) In response to the fourth comparison result being that the PD capacity of the first interface is less than the design power of the USB module (Step S71), the control circuit MCU in FIG. 2 turns on the second switch SW2, the fifth switch SW5 and the eighth switch SW8 and turns off the first switch SW1, the third switch SW3, the fourth switch SW4, the sixth switch SW6 and the seventh switch SW7 (Step S72); and
(2) In response to the fourth comparison result being that the PD capacity of the first interface is greater than or equal to the design power of the USB module (Step S73), the control circuit MCU in FIG. 2 turns on the second switch SW2, the third switch SW3, the fifth switch SW5 and the eighth switch SW8 and turns off the first switch SW1, the fourth switch SW4, the sixth switch SW6 and the seventh switch SW7 (Step S74).

In summary, the display device with multi-PD function and operating method thereof proposed in the present disclosure may reuse the PD capacity of the idle power adapters through the design of PD controllers and power management circuits, effectively improving the total power supply of the display device, so that the display device may simultaneously power one or more external devices to achieve the multi-PD function. It may not only greatly reduce the number of connection lines and chargers on the office desktop, making the overall working environment more tidy and efficient, but also greatly reduce the generation of electronic waste and reduce the large amount of materials and energy consumed in the manufacture of new power adapters as well as the emission of greenhouse gases such as carbon dioxide, thereby achieving the goals of resource conservation and efficient utilization and reducing carbon footprint.

The contents disclosed above are merely feasible embodiments of the present disclosure, and are not intended to limit the scope of the claims of the present disclosure. Therefore, all equivalent technical changes made based on the specification and the drawings of the present disclosure fall within the scope of the claims of the present disclosure.

What is claimed is:

1. A display device with multi-power delivery (PD) function, comprising:
an internal power supply;
a first interface;
a second interface;
a first PD controller, electrically connected to the first interface and configured to determine whether the first interface has a PD capability;
a second PD controller, electrically connected to the second interface and configured to determine whether the second interface has a first PD requirement; and
a control circuit, electrically connected to the first PD controller and the second PD controller and configured to selectively provide power from the internal power supply and/or the first interface according to a first determination result of the first PD controller, a second determination result of the second PD controller, the PD capability and the first PD requirement.

2. The display device according to claim 1, further comprising:
a third interface, electrically connected to the second PD controller,
wherein the second PD controller is further configured to determine whether the third interface has a second PD requirement.

3. The display device according to claim 2, further comprising:
a first power management circuit, electrically connected to the second interface;
a first switch, electrically connected between the first interface and the first power management circuit;
a second switch, electrically connected between the internal power supply and the first power management circuit;
a universal serial bus (USB) module;
a multi-channel PD path switching circuit, electrically connected between the internal power supply and the USB module and configured to selectively provide power to the USB module directly from the internal power supply or switch to provide power to the USB module from the first interface;
a third switch, electrically connected between the first interface and the multi-channel PD path switching circuit;
a fourth switch, electrically connected between the first interface and the third interface;
a fifth switch, electrically connected to the third interface;
a sixth switch, electrically connected to the first interface;
a second power management circuit, electrically connected between the fifth switch and the sixth switch;
a seventh switch, electrically connected between the internal power supply and the second power management circuit; and
an eighth switch, electrically connected between the internal power supply and the second power management circuit,
wherein the first switch to the eighth switch are all electrically connected to the control circuit.

4. The display device according to claim 3, wherein in response to the first determination result of the first PD controller being that the first interface has the PD capability, the second determination result of the second PD controller being that the second interface has the first PD requirement, and the third interface has the second PD requirement, the control circuit compares the PD capability of the first interface, the first PD requirement of the second interface, the second PD requirement of the third interface, and a design power of the USB module to generate a first comparison result.

5. The display device according to claim 4, wherein in response to the first comparison result being that the first PD requirement of the second interface, the second PD requirement of the third interface, and the design power of the USB module are all greater than the PD capacity of the first interface, the control circuit turns on the second switch, the fifth switch, and the eighth switch and turns off the first switch, the third switch, the fourth switch, the sixth switch, and the seventh switch.

6. The display device according to claim 4, wherein in response to the first comparison result being that the PD capability of the first interface is greater than or equal to the design power of the USB module but less than the second PD requirement of the third interface, the control circuit turns on the second switch, the third switch, the fifth switch, and the eighth switch and turns off the first switch, the fourth switch, the sixth switch, and the seventh switch.

7. The display device according to claim 4, wherein in response to the first comparison result being that the PD capability of the first interface is greater than or equal to the second PD requirement of the third interface but less than a sum of the design power of the USB module and a second specific value, the control circuit turns on the second switch and the fourth switch and turns off the first switch, the third switch, the fifth switch, the sixth switch, the seventh switch, and the eighth switch, wherein the second specific value is the second PD requirement of the third interface divided by a specific ratio.

8. The display device according to claim 4, wherein in response to the first comparison result being that the PD capability of the first interface is greater than or equal to a sum of the design power of the USB module and a second specific value but less than a sum of the design power of the USB module, a first specific value, and the second specific value, the control circuit turns on the second switch, the third switch, the fifth switch, and the sixth switch and turns off the first switch, the fourth switch, the seventh switch, and the eighth switch, wherein the first specific value is obtained by dividing the first PD requirement of the second interface by a specific ratio and the second specific value is obtained by dividing the second PD requirement of the third interface by the specific ratio.

9. The display device according to claim 4, wherein in response to the first comparison result being that the PD capability of the first interface is greater than or equal to a sum of the design power of the USB module and a first specific value and a second specific value, the control circuit turns on the first switch, the third switch, the fifth switch, and the sixth switch and turns off the second switch, the fourth switch, the seventh switch and the eighth switch, wherein the first specific value is obtained by dividing the first PD requirement of the second interface by a specific ratio and the second specific value is obtained by dividing the second PD requirement of the third interface by the specific ratio.

10. The display device according to claim 3, wherein in response to the first determination result being that the first interface has the PD capability, the second determination result that the second interface has the first PD requirement and the third interface does not have the second PD requirement, the control circuit compares the PD capability of the first interface, the first PD requirement of the second interface and a design power of the USB module to generate a second comparison result.

11. The display device according to claim 10, wherein in response to the second comparison result being that the first PD requirement of the second interface and the design power of the USB module are both greater than the PD capacity of the first interface, the control circuit turns on the second switch, the fifth switch, and the eighth switch and turns off the first switch, the third switch, the fourth switch, the sixth switch, and the seventh switch; in response to the second comparison result being that the PD capacity of the first interface is greater than or equal to the design power of the USB module but less than a sum of the design power of the USB module and a first specific value, the control circuit turns on the second switch, the third switch, the fifth switch, and the eighth switch and turns off the first switch, the fourth switch, the sixth switch, and the seventh switch; in response to the second comparison result being that the PD capacity of the first interface is greater than or equal to a sum of the design power of the USB module and the first specific value, the control circuit turns on the first switch, the third switch, the fifth switch, and the eighth switch and turns off the second switch, the fourth switch, the sixth switch, and the seventh switch, wherein the first specific value is the first PD requirement of the second interface divided by a specific ratio.

12. The display device according to claim 3, wherein in response to the first determination result of the first PD controller being that the first interface has the PD capability, the second determination result of the second PD controller being that the third interface has the second PD requirement, and the second interface does not have the first PD requirement, the control circuit compares the PD capability of the first interface, the second PD requirement of the third interface and a design power of the USB module to generate a third comparison result.

13. The display device according to claim 12, wherein in response to the third comparison result being that the second PD requirement of the third interface and the design power of the USB module are both greater than the PD capacity of the first interface, the control circuit turns on the second switch, the fifth switch, and the eighth switch and turns off the first switch, the third switch, the fourth switch, the sixth switch, and the seventh switch; in response to the third comparison result being that the PD capacity of the first interface is greater than or equal to the design power of the USB module but less than the second PD requirement of the third interface, the control circuit turns on the second switch, the fifth switch and the eighth switch and turns off the first switch, the third switch, the fourth switch, the sixth switch, and the seventh switch; in response to the third comparison result being that the PD capacity of the first interface is greater than or equal to the design power of the USB module but less than the second PD requirement of the third interface, the control circuit turns on the second switch, the fifth switch and the eighth switch and turns off the first switch, the third switch, the fourth switch, the sixth switch, and the seventh switch; in response to the third comparison result being that the PD capacity of the first interface is greater than or equal to a sum of the design power of the USB module and the second specific value, the control circuit turns on the second switch, the fifth switch, and the eighth switch and turns off the first switch, the third switch, the fourth switch, the sixth switch, and the seventh switch, wherein the second specific value is the second PD requirement of the third interface divided by the specific ratio.

14. The display device according to claim 3, wherein the multi-channel PD path switching circuit comprises:
an internal power input terminal electrically connected to the internal power supply;
a USB module power input terminal electrically connected to the USB module;
a first P-type high-power metal-oxide-semiconductor field-effect transistor (MOSFET) electrically connected between the internal power input terminal and the USB module power input terminal; and
a diode electrically connected between the first interface and the USB module power input terminal.

15. The display device according to claim 14, wherein the multi-channel PD path switching circuit further comprises:
a second P-type high-power MOSFET electrically connected to the first P-type high-power MOSFET and a ground terminal respectively;
a third P-type high-power MOSFET electrically connected to the second P-type high-power MOSFET and the ground terminal respectively;
a first resistor electrically connected to the internal power input terminal;
a second resistor and a third resistor connected in series between the internal power input terminal and the ground terminal;
a fourth resistor and a fifth resistor connected in series between the first interface and the ground terminal;
a sixth resistor electrically connected between the first P-type high-power MOSFET and the second P-type high-power MOSFET;
a first capacitor electrically connected between the internal power input terminal and the ground terminal;
a second capacitor electrically connected between the internal power input terminal and the sixth resistor;
a third capacitor electrically connected between the USB module power input terminal and the ground terminal; and
a Schottky diode electrically connected between the internal power input terminal and the sixth resistor.

16. A display device operating method, comprising:
determining whether a first interface of a display device has a power delivery (PD) capability to generate a first determination result;
determining whether a second interface of the display device has a first PD requirement to generate a second determination result; and
selectively determining to provide power through an internal power supply and/or the first interface according to the first determination result, the second determination result, the PD capability and the first PD requirement.

17. The display device operating method according to claim 16, wherein the second determination result also comprises whether a third interface of the display device has a second PD requirement.

18. The display device operating method according to claim 17, further comprises:
in response to the first determination result being that the first interface has the PD capability, the second determination result being that the second interface has the first PD requirement and the third interface has the second PD requirement, comparing the PD capability of the first interface, the first PD requirement of the second interface, the second PD requirement of the third interface and a design power of the USB module to generate a first comparison result; and
selectively determining the internal power supply and/or the first interface to provide power according to the first comparison result.

19. The display device operating method according to claim 17, further comprises:
in response to the first determination result being that the first interface has the PD capability, the second determination result being that the second interface has the first PD requirement and the third interface does not have the second PD requirement, comparing the PD capability, the first PD requirement, and a design power of the USB module to generate a second comparison result; and
selectively determining the internal power supply and/or the first interface to provide power according to the second comparison result.

20. The display device operating method according to claim 17, further comprises:
in response to the first determination result being that the first interface has the PD capability, the second determination result being that the third interface has the second PD requirement and the second interface does not have the first PD requirement, comparing the PD capability, the second PD requirement and a design power of the USB module to generate a third comparison result; and
selectively determining the internal power supply and/or the first interface to provide power according to the third comparison result.
